(19) United States
(12) Patent Application Publication
(10) Pub. No.: US 2008/0155191 A1
(43) Pub. Date: Jun. 26, 2008

(54) Systems and methods for providing heterogeneous storage systems

(76) Inventors: Robert J. Anderson, (US); Nate E. Dire, Seattle, WA (US); Neal T. Fachan, Seattle, WA (US); Peter J. Godman, Seattle, WA (US); Aaron J. Passey, Seattle, WA (US); David W. Richards, Seattel, WA (US); Darren P. Schack, Seattle, WA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/643,719

(22) Filed: Dec. 21, 2006

(51) Int. Cl. G06F 12/00

(52) U.S. Cl. 711/114

(57) ABSTRACT

Embodiments of the present invention provide systems and methods for using heterogeneous containers where the available space on the containers is of two or more different sizes. In some embodiments, the heterogeneous containers may store some data under one protection scheme and other data under one or more other data protection schemes.

### BACKGROUND OF THE INVENTION

1. Field of the Invention

This invention relates generally to the field of data storage and in particular to distributed data storage.

2. Description of the Related Art

The explosive growth of the Internet has ushered in a new area in which information is exchanged and accessed on a constant basis. In response to this growth, there has been an increase in the size of data that is being stored. Users are demanding more than standard HTML documents, wanting access to a variety of data, such as, audio data, video data, image data, and programming data. Thus, there is a need for data storage that can accommodate large sets of data, while at the same time provide fast and reliable access to the data.

One response has been to utilize single storage devices which may store large quantities of data but have difficulties providing high throughput rates. As data capacity increases, the amount of time it takes to access the data increases as well. Processing speed and power has improved, but disk I/O (Input/Output) operation performance has not improved at the same rate making I/O operations inefficient, especially for large data files. One solution has been to break up large data files and store them in distributed systems. However, such systems store a fixed amount of data and are often costly to replace.

### SUMMARY OF THE INVENTION

The embodiments disclosed herein generally relate to distributed data storage.

In one embodiment, a storage system is provided. The storage system includes a plurality of n storage containers, x₁, x₂, to xₙ, configured to store logical data and data protection data, wherein: n is greater than 1; the size of x₁≦the size of x₂≦ . . . the size of xₙ₋₁≦the size of xₙ and the size of x₁<the size of xₙ; the plurality of n storage containers utilize more than ((n−m)*size of x₁) for storing logical data, where m is the number of failed storage containers the system can handle; and the logical data and data protection data may include striped data and mirrored data.

In a further embodiment, a storage system is provided. The storage system includes a plurality of n storage containers, x₁, x₂, to xₙ, configured to store logical data and data protection data, wherein: n is greater than 1; the size of x₁≦the size of x₂≦ . . . the size of xₙ₋₁≦the size of xₙ and the size of x₁<the size of xₙ; the plurality of n storage containers utilize more than ((n−m)*size of x₁) for storing logical data, where m is the number of failed storage containers the system can handle; and the storage containers are locally accessed disk drives.

In an additional embodiment, a storage system is provided. The storage system includes a plurality of n storage containers, x₁, x₂, to xₙ, configured to store logical data and data protection data, wherein: n is greater than 1; the size of x₁≦the size of x₂≦ . . . the size of xₙ₋₁≦the size of xₙ and the size of x₁<the size of xₙ; the plurality of n storage containers utilize more than (n*size of x₁) for storing physical data; and the logical data and data protection data may include striped data and mirrored data.

In a further embodiment, a method of storing data on heterogeneous storage containers is provided. The method includes receiving a total number of storage containers; receiving a minimum number of protection blocks; determining a first protection scheme; storing a first plurality of stripes of data across all of the storage containers at the first protection until the smallest container of all of the storage containers is full; determining a second protection scheme; and storing a second plurality of stripes of data across the non-full storage containers at the second protection until the smallest container of the non-full storage containers is full.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### BRIEF DESCRIPTION OF THE DRAWINGS

FIG. 1 illustrates one embodiment of a system that includes a storage apparatus comprising multiple storage containers.

FIGS. 2A and 2B illustrate one embodiment of two exemplary storage apparatuses.

FIGS. 3A and 3B illustrate embodiments of striping across storage apparatuses.

FIG. 4 illustrates one embodiment of storage containers.

FIGS. 5A and 5B illustrate additional embodiments of storage containers.

FIG. 6 illustrates one embodiment of multiple protection policies on heterogeneous storage containers.

FIG. 7 illustrates one embodiment of data stored using multiple protection policies on heterogeneous storage containers.

FIG. 8 illustrates one embodiment of data and their related protection policies.

FIG. 9 illustrates one embodiment of multiple protection policies on heterogeneous storage containers using one embodiment of parity protection.

FIG. 10 illustrates one embodiment of data stored using multiple protection schemes on heterogeneous storage containers using one embodiment of parity protection.

FIG. 11 illustrates one embodiment of data blocks and their related parity blocks using one embodiment of parity protection.

FIG. 12 illustrates a flowchart of one embodiment of storing data on heterogeneous storage containers.

FIG. 13 illustrates a flowchart of one embodiment of storing data using multiple protection policies and/or levels.

These and other features will now be described with reference to the drawings summarized above. The drawings and the associated descriptions are provided to illustrate the embodiments of the invention and not to limit the scope of the invention. Throughout the drawings, reference numbers may be re-used to indicate correspondence between referenced elements. In addition, the first digit of each reference number generally indicates the figure in which the element first appears.

### DETAILED DESCRIPTION OF PREFERRED EMBODIMENTS

Systems, methods, processes, and data structures which represent one embodiment of an example application of the invention will now be described with reference to the drawings. Variations to the systems, methods, processes, and data structures which represent other embodiments will also be described.

### I. Overview

In a traditional RAID system, a single controller is attached to a set of drives and the controller stores data on the drives. These drives are of the same size and they always store the same amount of data. Such drives are often referred to as homogeneous drives since they are the same size throughout the system. While homogeneous drives may be easier to implement since they are of the same size, they do not allow for much flexibility such as, for example, when more space is needed and/or part of a drive becomes unavailable.

Embodiments of the present invention provide systems and methods for using heterogeneous containers where the available space in the containers is of two or more different sizes. In some embodiments, the heterogeneous containers may store some data under one protection scheme and other data under one or more other data protection schemes. This allows for use of more of the container space.

In some embodiments, the heterogeneous containers may be of different sizes and/or may have a different amount of available space. For example, one system of heterogeneous containers includes six containers each of size X, wherein the first three containers have only 75% of their space available whereas the last three containers have 100% of their space available. In another example, one system of heterogeneous containers includes 20 containers, the first 3 of size 250 G, the next 8 of size 500 G, the next 7 of size 110 G, and the last 2 of size 2064 G with all of the containers having 100% of their space available. In a further example, one system of heterogeneous containers includes three distributed nodes, the first node of size 3.6 TB with 70% of its space available, the second node of size 3.6 TB with 100% of its space available, and a third node of size 4.8 TB with 80% of its space available.

In some embodiments, the heterogeneous containers store distributed data that can be protected using one or more types of data protection. For example, a first set of data may be protected at 5+3, a second set of data may be protected at 4+2, a third set of data may be protected at 3+1, and a fourth set of data may be mirrored at level 2×.

Moreover, in some embodiments, the system is dynamic such that containers can be added and/or grown without having to fully reconfigure the system.

### II. System Architecture

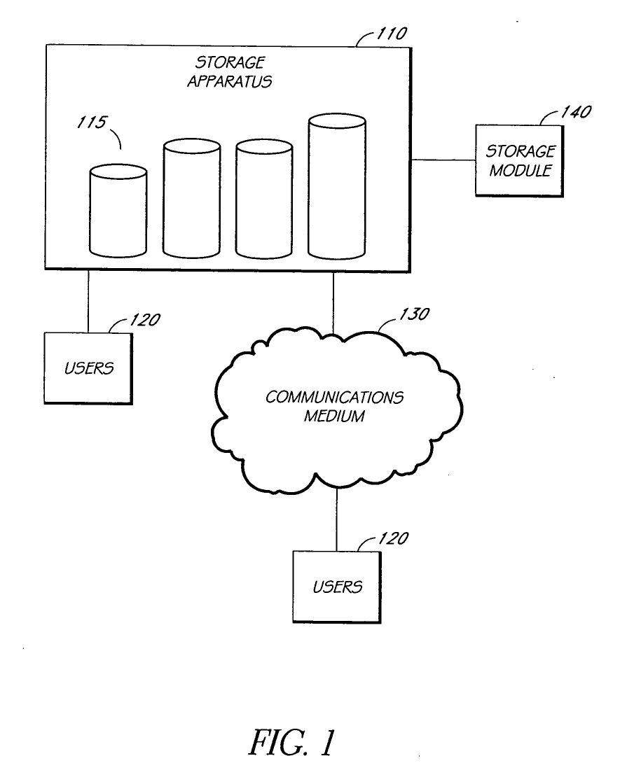

FIG. 1 illustrates one embodiment of a heterogeneous storage system that includes a storage apparatus 110 in communication with users 120. The communication may be direct communication and/or via a communications medium 130. In one embodiment, users are able to access data stored on the storage apparatus 110. Furthermore, in one embodiment, the heterogeneous storage system includes a storage module 140 in communication with the storage apparatus 110 that stores data on the storage apparatus.

A. Storage Apparatus

In one embodiment, the storage apparatus 110 include two or more storage containers 115. The storage apparatus 110 of FIG. 1 includes four storage containers 115. In one embodiment, the storage containers include a memory that may be used to store data. In addition, the storage containers may include drives, nodes, disks, clusters, objects, drive partitions, virtual volumes, volumes, drive slices, and so forth. Moreover, the storage containers may be implemented using a variety of products that are well known in the art, such as, for example, an ATA100 devices, SCSI devices, and so forth. In addition, the size of the storage containers may be the same size or may be of two or more sizes.

In some embodiments, part of a container may be unavailable. There are many reasons why a container may not be available such as, for example, a part of a container may be corrupted, reserved for other use by the system, disconnected from the system, a drive may be lost, and so forth.

It is recognized that the storage containers may store a variety of data including file data, metadata, and data protection data. In the type of file data may include static data, data streams, executable file data, and so forth.

It is recognized that there may be other storage containers that are not part of the set. For example, while there may be a set of six heterogeneous containers, there maybe be other containers that communicated with the system or are part of the system.

B. Storage Module

In one embodiment, the storage module 140 stores data in one or more storage containers 115 of the storage apparatus 110. In addition, in some embodiments, the storage module 140 stores the data using one or more data protection policies and/or levels. In one embodiment, the storage module 140 communicates directly with the storage apparatus 110, whereas in other embodiments, some or all of the communication between the storage module 140 and the storage apparatus 110 is via a communications medium. In one embodiment, the storage module stores data by using all containers in the set for each stripe until the smallest container(s) is filled, using the remaining containers for the subsequent stripes until the next smallest container(s) is filled and so forth until there are not enough containers to maintain a minimum level of protection. This and other embodiments of storing data are discussed further below.

In some embodiments, the storage module stores data based on the data that is available when the data is being stored. This flexibility allows the system to add, remove, and/or change containers to the system without having to stop and fully reconfigure the system. In addition, if the capacity of a container changes, such as, for example, if a sector of a container becomes unreadable, the system can then continue to store date on the remaining area of the container as well as on the other containers even though the container is now of a new, different size.

The word module refers to logic embodied in hardware or firmware, or to a collection of software instructions, possibly having entry and exit points, written in a programming language, such as, for example, C or C++. A software module may be compiled and linked into an executable program, installed in a dynamically linked library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Moreover, although in some embodiments a module may be separately compiled, in other embodiments a module may represent a subset of instructions of a separately compiled program, and may not have an interface available to other logical program units.

The storage module 140 may run on a variety of computer systems such as, for example, a computer, a server, a smart storage unit, and so forth. In one embodiment, the computer may be a general purpose computer using one or more microprocessors, such as, for example, an Intel® Pentium® processor, an Intel® Pentium® II processor, an Intel® Pentium® Pro processor, an Intel® Pentium® IV processor, an Intel® Pentium® D processor, an Intel® Core™ processor, an xx86 processor, an 8051 processor, a MIPS processor, a Power PC processor, a SPARC processor, an Alpha processor, and so forth. The computer may run a variety of operating systems that perform standard operating system functions such as, for example, opening, reading, writing, and closing a file. It is recognized that other operating systems may be used, such as, for example, Microsoft® Windows® 3.X, Microsoft® Windows 98, Microsoft® Windows® 2000, Microsoft® Windows® NT, Microsoft® Windows® CE, Microsoft® Windows® ME, Microsoft® Windows® XP, Palm Pilot OS, Apple® MacOS®, Disk Operating System (DOS), UNIX, IRIX, Solaris, SunOS, FreeBSD, Linux®, or IBM® OS/2® operating systems.

C. Communications Medium

The communication medium 130 may be one or more networks, including, for example, the Internet, a local area network (LAN), a wide area network (WAN), a wireless network, a wired network, an intranet, a bus, and so forth.

D. Data Protection

It is recognized that the heterogeneous storage system may utilize one or more data protection policies and/or levels. For example, the heterogeneous storage system may implement one or more error correcting codes. These codes include a code “in which each data signal conforms to specific rules of construction so that departures from this construction in the received signal can generally be automatically detected and corrected. It is used in computer data storage, for example in dynamic RAM, and in data transmission.” (http://en.wikipedia.org/wiki/Error_correcting_code). Examples of error correction code include, but are not limited to, Hamming code, Reed-Solomon code, Reed-Muller code, Binary Golay code, convolutional code, and turbo code. In some embodiments, the simplest error correcting codes can correct single-bit errors and detect double-bit errors, and other codes can detect or correct multi-bit errors.

In addition, the error correction code may include forward error correction, erasure code, fountain code, parity protection, and so forth. “Forward error correction (FEC) is a system of error control for data transmission, whereby the sender adds redundant to its messages, which allows the receiver to detect and correct errors (within some bound) without the need to ask the sender for additional data.” (http://en.wikipedia.org/wiki/forward error correction). Fountain codes, also known as rateless erasure codes, are “a class of erasure codes with the property that a potentially limitless sequence of encoding symbols can be generated from a given set of source symbols such that the original source symbols can be recovered from any subset of the encoding symbols of size equal to or only slightly larger than the number of source symbols.” (http://en.wikipedia.org/wiki/Fountain code). “An erasure code transforms a message of n blocks into a message with >n blocks such that the original message can be recovered from a subset of those blocks” such that the “fraction of the blocks required is called the rate, denoted r (http://en.wikipedia.org/wiki/Erasure code). “Optimal erasure codes produce n/r blocks where any n blocks is sufficient to recover the original message.” (http://en.wikipedia.org/wiki/Erasure code). “Unfortunately optimal codes are costly (in terms of memory usage, CPU time or both) when n is large, and so near optimal erasure codes are often used,” and “[t]hese require (1+ε)n blocks to recover the message. Reducing ε can be done at the cost of CPU time.” (http://en.wikipedia.ori/wiki/Erasure code).

The data protection may include other error correction methods, such as, for example, Network Appliance's RAID double parity methods, which includes storing data in horizontal rows, calculating parity for data in the row, and storing the parity in a separate row parity disk, along with other double parity methods, diagonal parity methods, and so forth.

In addition, for each protection policy, there may be one or more protection schemes. For example, a protection policy of “n+m,” there may be several levels of protection, such as, for example, n₁+m, n₂+m, n₃+m, and so forth. As another example, for an n+1 protection policy, data may be protected at the following levels: 3+1, 2+1, and 2×. The system may include more than one data protection policy and/or level, referred to as protection schemes.

### III. Example Embodiments

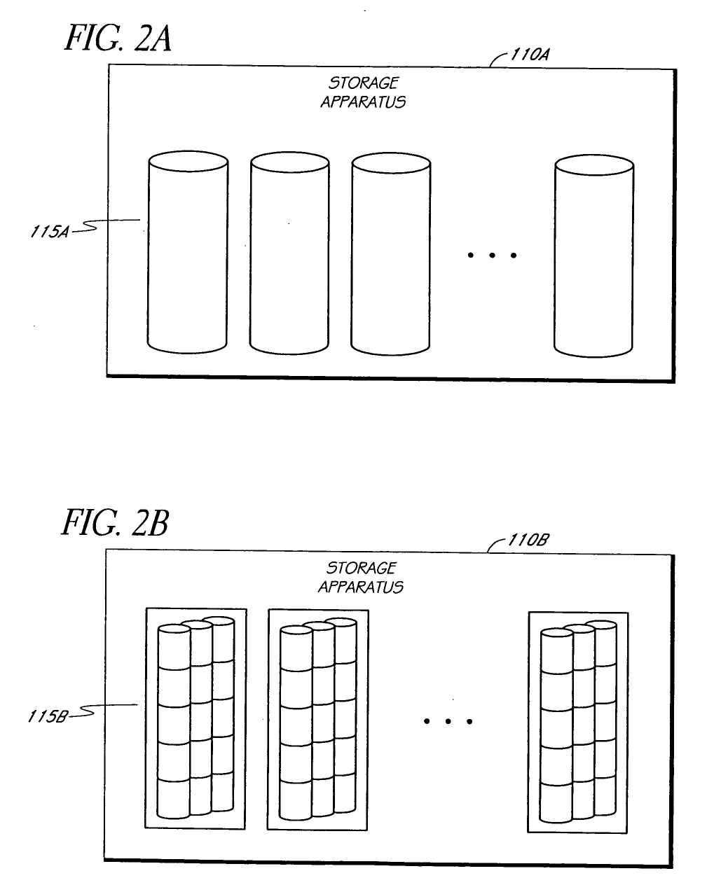

FIGS. 2A and 2B illustrate embodiments of two exemplary storage apparatuses. The storage containers 115A of the storage apparatus 110A comprise hard drives, while the storage containers of the storage apparatus 110B comprise nodes. It is recognized that a variety of storage containers may be used, as discussed further below. In addition, a combination of storage containers 115 may be used in a storage apparatus 110. For example, a storage apparatus 110 may include two containers of hard drives, and five containers of nodes. In some embodiments, the storage containers are locally accessed, whereas in other embodiments, one or more of the storage containers are remotely accessed. In some embodiments, one or more of the containers are part of a distributed system. It is a recognized that a variety of configurations of storage apparatuses may be used.

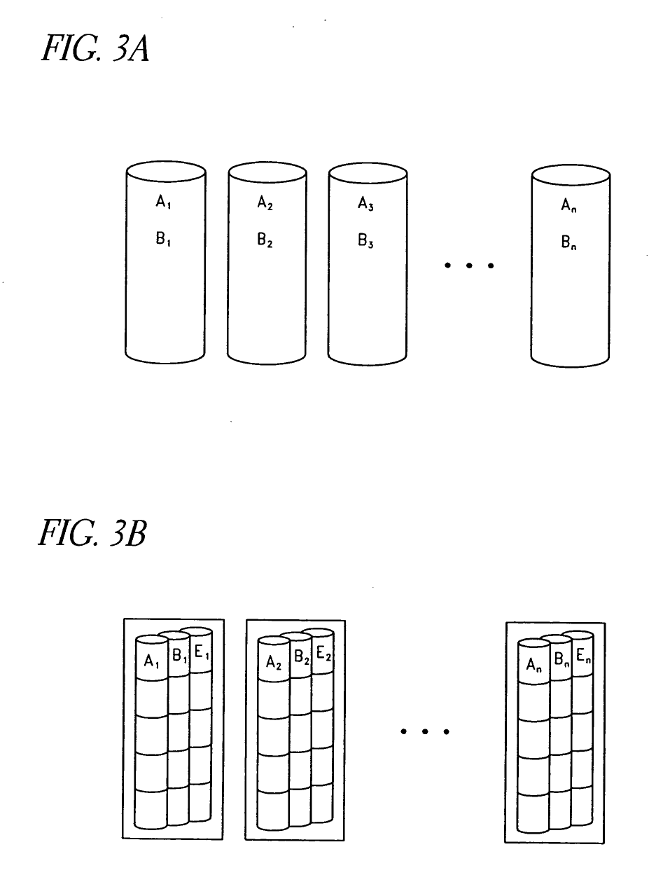

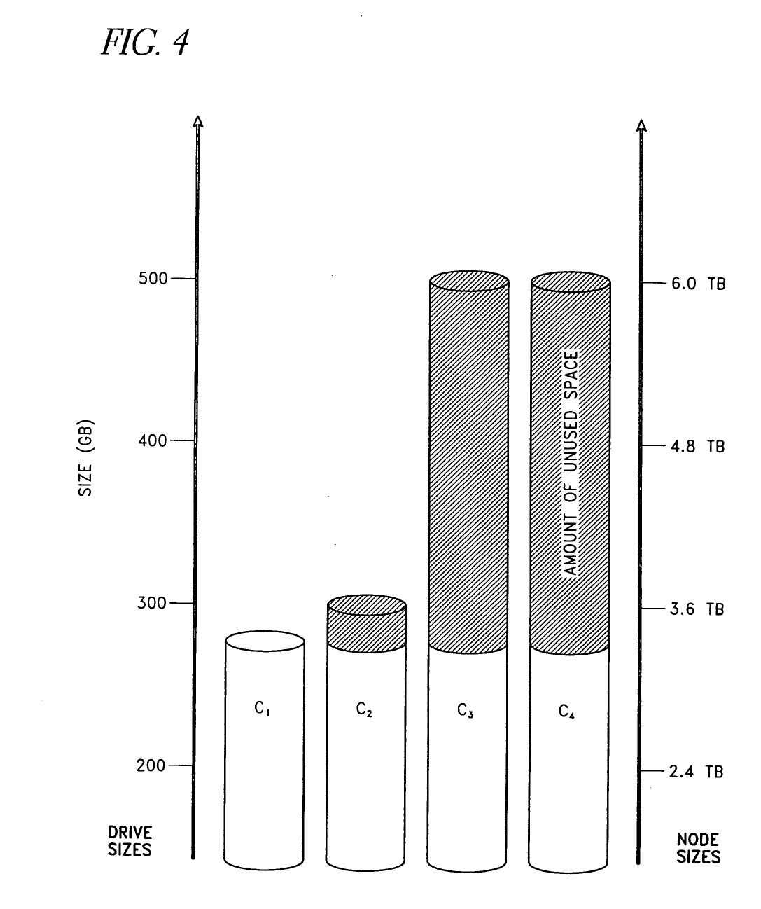

FIGS. 3A and 3B illustrate one embodiment of striping of data across the storage apparatuses 110A, 11B, respectively. In FIG. 3A, the storage containers are drives, where a first set of data A₁, A₂, A₃, . . . Aₙ and a second set of data B₁, B₂, B₃, . . . Bₙ is striped across the multiple drives. In FIG. 3B, the storage containers are nodes which include three drives, where a first set of data A₁, A₂, A₃, . . . Aₙ, a second set of data B₁, B₂, B₃, . . . Bₙ, and a third set of data E₁, E₂, E₃, . . . Eₙ is striped across the multiple nodes. It is recognized that in other embodiments some of the data may be striped across multiple drives within the multiple nodes. While the storage containers in FIGS. 3A and 3B are of the same size, it is recognized that the storage containers may be of different sizes and/or may have different amounts of available space.

FIG. 4 illustrates exemplary storage containers 115 of a storage apparatus 110, such as either the apparatuses 110A or 110B. Thus, the storage containers C₁, C₂, C₃, C₄ may represent different storage containers, such as, for example, nodes, or drives. The size indicators on the left side of the drawing indicate exemplary sizes if the storage containers 115 comprise hard drives, and the size indicators on the right side of the drawing indicate exemplary sizes if the storage containers comprise nodes. In the embodiment of FIG. 4, the portions of the storage containers that are shaded are those portions that are typically not used by a RAID storage system having containers of varying sizes, thereby resulting in much storage space being wasted.

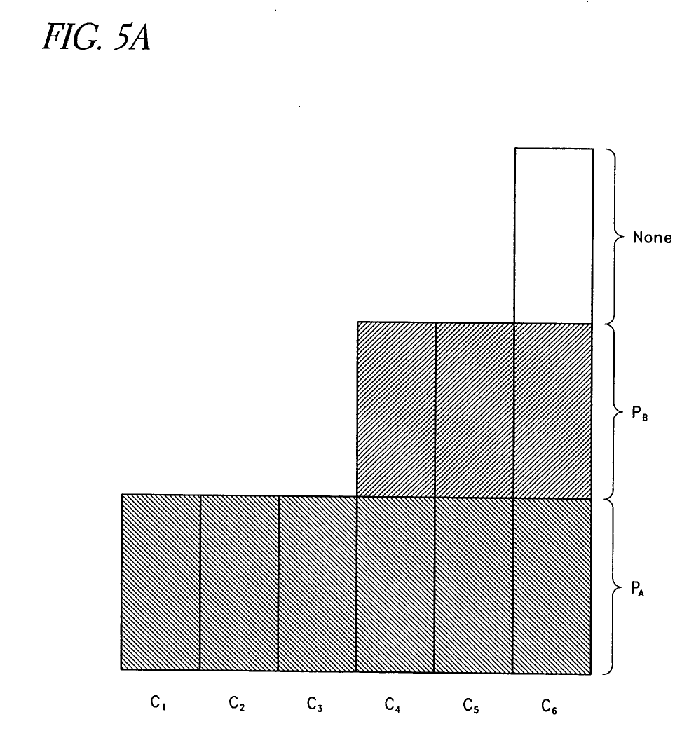

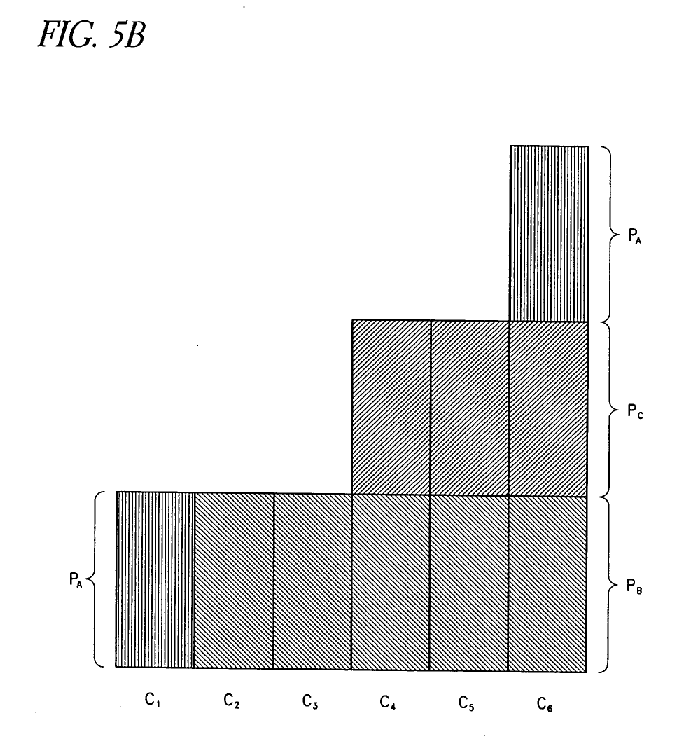

FIG. 5A illustrates six storage containers C₁, C₂, C₃, C₄, C₅, C₆ wherein containers C₄, C₅, have twice the available capacity as containers C₁, C₂, C₃, and container C₆ has three times the available capacity as containers C₁, C₂, C₃. In this embodiment, the storage system is configured to utilize the extra capacity of the containers C₁, C₂, C₃ to store data at a different protection scheme. Thus, in the embodiment of FIG. 5A, the capacity of all of containers C₁, C₂, C₃, one half of the capacity of containers C₄, C₅, and one third of the capacity of container C₆ are used to store files using a first protection, P_{A}. Once the capacity of container C₁, C₂, C₃, one half of the capacity of containers C₄, C₅, and one third of the capacity of container C₆ are filled, the other half of the containers C₄, C₅, and another third of container C₆ are used to store another portion of data using a second protection, P_{B}. In the embodiment of FIG. 5A, the storage container C₆ comprises a larger capacity than the remaining containers C₁, C₂, C₃, C₄, C₅ and, in this embodiment, one third of the capacity of C₆ is not utilized due to the protection requirements.

FIG. 5B illustrates the same container configuration of FIG. 5A, wherein the extra storage capacity of container C₆ is utilized by mirroring an entire copy of C₁ in C₆. Accordingly, the capacity of all of containers C₁ and one third of C₆ is utilized using a first protection, P_{A}. The capacity of all of containers C₂, C₃, one half of the capacity of containers C₄, C₅, and one third of the capacity of container C₆ are used to store files using a second protection, P_{B}. Another half of the capacity of containers C₄, C₅, and one third of the capacity of container C₆ are used to store another portion of data using a third protection, P_{C}. In the embodiment of FIG. 5A, even though the storage container C₆ comprises a larger capacity than the remaining containers C₁, C₂, C₃, C₄, C₅ and the entire capacity of C₆ is utilized due to the protection requirements. Assuming a +1 protection policy, in both FIGS. 5A and 5B, the same amount of logical data is stored, but more of the physical data space is used in FIG. 5B.

FIGS. 5A and 5B illustrate embodiments of storing data with multiple protection schemes among the storage containers. It is recognized that a variety of configurations may be used using multiple containers, different sizes of containers, and/or different protection schemes.

A. Example of Multiple Protection Schemes

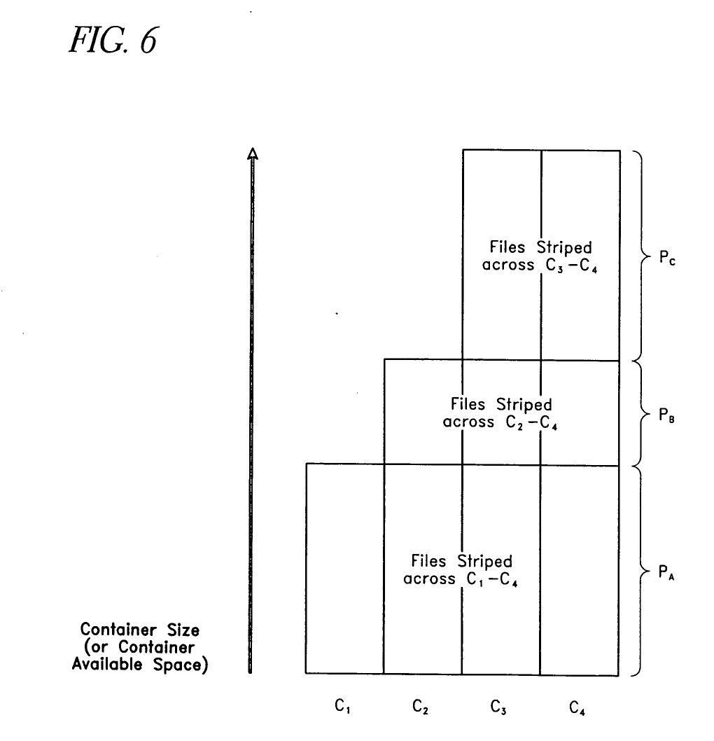

FIG. 6 illustrates one embodiment of the use of multiple protection schemes on heterogeneous containers wherein a set of data is first striped across C₁, C₂, C₃, C₄ using protection P_{A}, then striped also striped across C₂, C₃, C₄ using protection P_{B}, and also striped across C₃, C₄ using protection P_{C}. The set of data may include, for example, a portion of a file, a volume a directory, and so forth. Even though the containers are of differing sizes, the system utilizes more space than the maximum space of the smaller container.

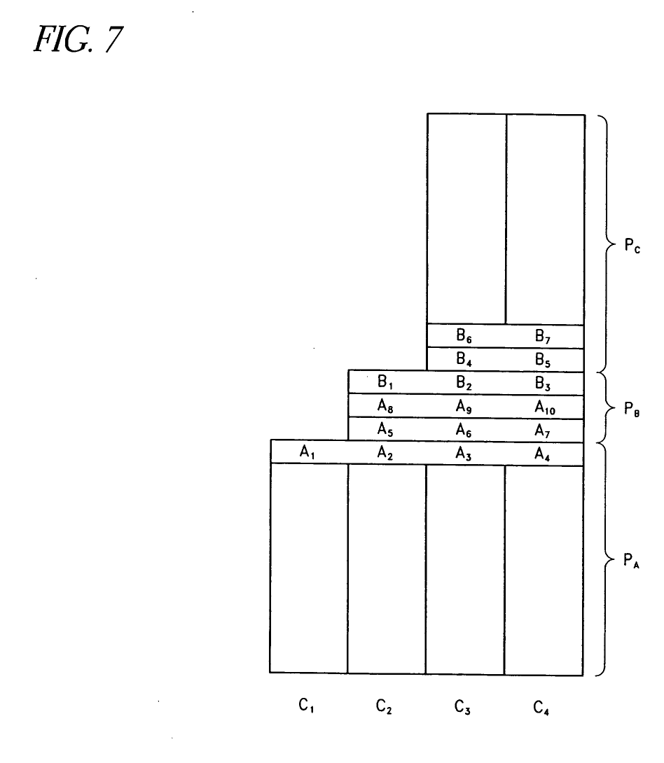

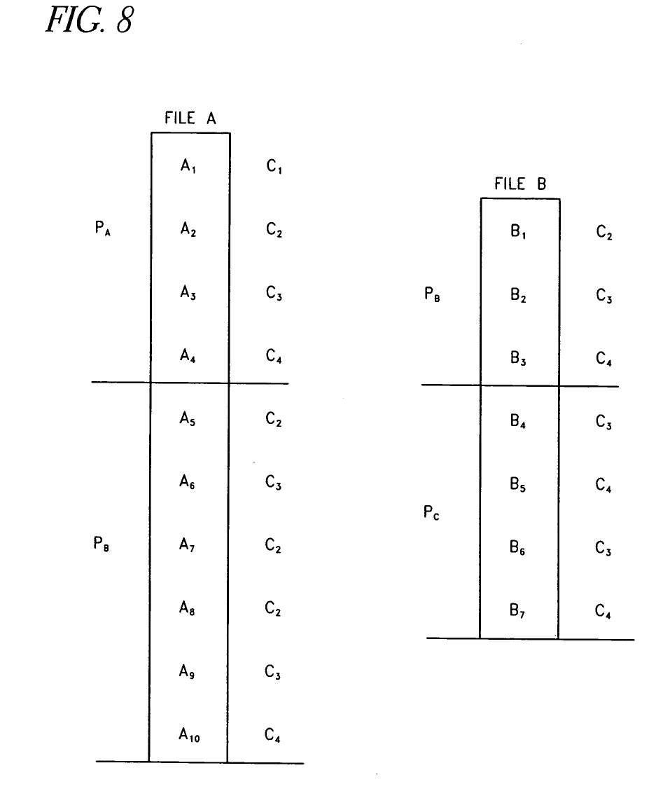

FIG. 7 illustrates an embodiment of a single data set that is striped using multiple protection schemes. For example, the a first four blocks of file A are striped using protection P_{A}, across storage containers C₁, C₂, C₃, C₄, while the second six blocks of File A are striped across only three storage containers C₂, C₃, C₄ using protection P_{B}. Similarly, File B is striped across the heterogeneous storage containers using two protection schemes such that the first three blocks of File B are striped across three storage containers C₂, C₃, C₄ using protection P_{B} and four blocks of File B are striped across two storage containers C₂, C₃, C₄ using protection P_{C}.

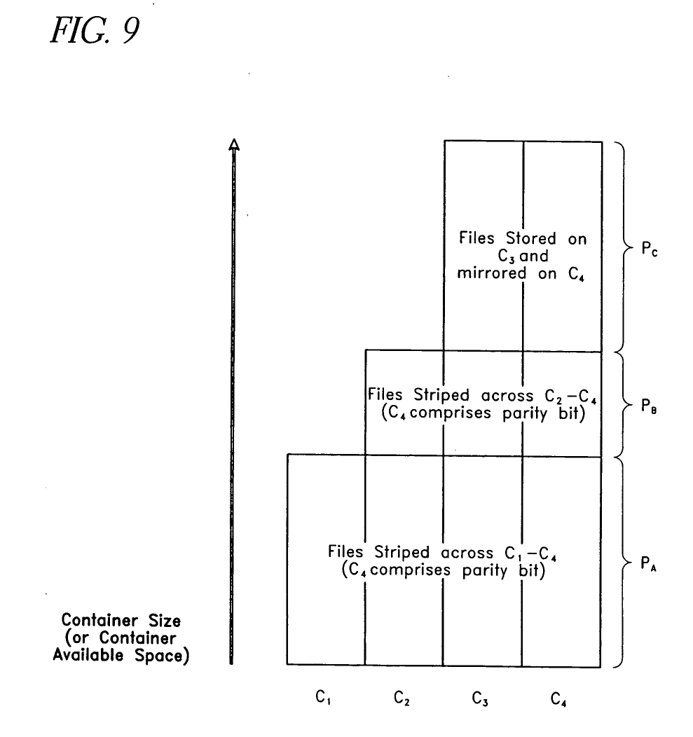

FIG. 8 illustrates the blocks A₁, A₂, A₃, . . . A₁₀ and blocks B₁, B₂, B₃, B₇, where the protection schemes of each block is indicated by P_{A}, P_{B}, and P_{C}. Additionally, the storage container that each of the data blocks is stored on is also indicated.

B. Example of Multiple Protection Schemes Using Parity Protection

FIG. 9 illustrates one embodiment of the use of multiple protection schemes on heterogeneous containers using +1 parity protection. In the illustrated embodiment, a file is first striped across C₁, C₂, C₃, C₄ using protection P_{A}, namely 3+1 parity, where the data blocks are stored on C₁, C₂, C₃ and parity blocks are stored on C₄. The file is then striped across C₂, C₃, C₄ using protection P_{B}, namely 2+1 parity, where the data blocks are stored on C₂, C₃ and parity blocks are stored on C₄. The file is then mirrored using protection P_{C}, namely 2× mirroring or 1+1 parity, where the data blocks are stored on C₃ and a mirrored copy of the blocks are stored on C₄. Even though the containers are of differing sizes, the system utilizes more space than the collective space of size of the smaller container on each of the containers.

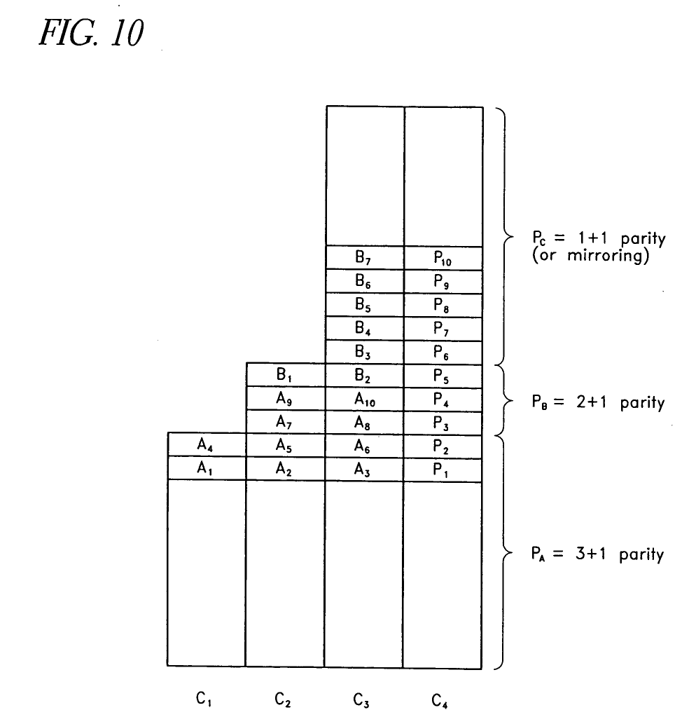

FIG. 10 illustrates an embodiment of data blocks and parity blocks that are striped using multiple parity protection schemes. For example, the a first six data blocks of File A with their parity blocks are striped using protection P_{A}, 3+1 parity, across storage containers C₁, C₂, C₃, C₄, while the second four data blocks of File A with their parity blocks are striped across only three storage containers C₂, C₃, C₄ using protection P_{B}, 2+1 parity. Similarly, File B is striped using two protection schemes such that the first two data blocks of File B with their corresponding parity are striped across three storage containers C₂, C₃, C₄ using protection P_{B}, 2+1 parity, and five data blocks with their corresponding parity of File B are striped across two storage containers C₃, C₄ using protection P_{C}, 2× mirroring or 1+1 parity. While FIG. 10 illustrates storing the parity data on C₄ it is recognized that the parity or error correction data may be stored on different containers and not necessarily the largest container. In addition, the parity data or error correction data may be stored on different containers for one or more stripes. Furthermore, while the figures show the capacity of the containers, the data (parity and block data) does not necessarily have to be stored contiguously within the containers. The data can be stored in various locations.

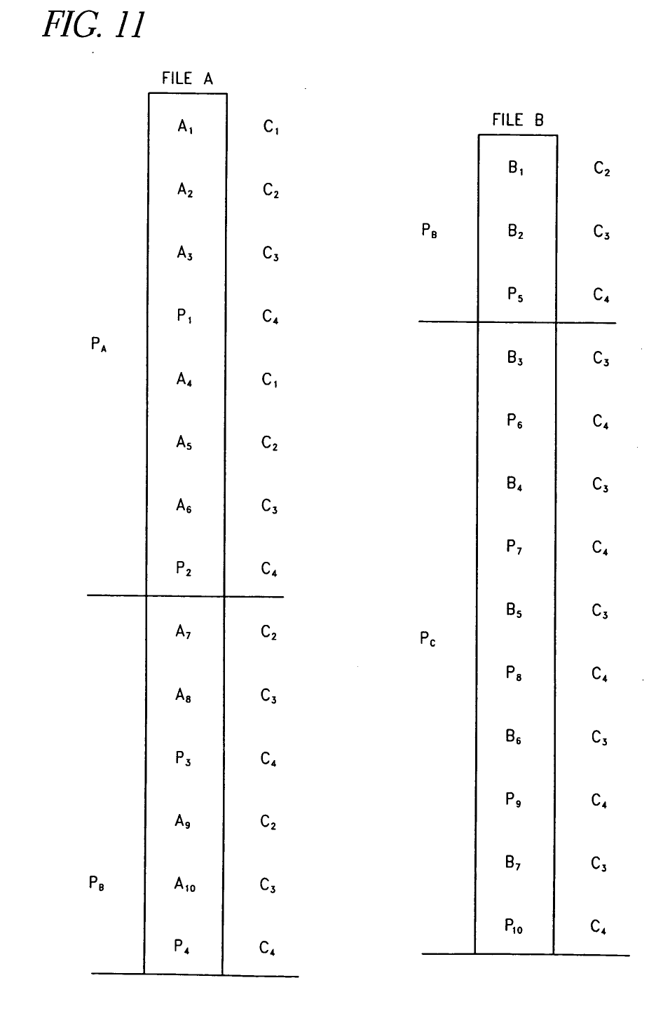

FIG. 11 illustrates the data blocks A₁, A₂, A₃, . . . A₁₀ and the data blocks B₁, B₂, B₃, . . . B₇, where the protection schemes of each set of data blocks are indicated by P_{A}, P_{B}, and P_{C}. Additionally, the storage container that each of the data blocks is stored on is also indicated.

C. Distributed File System

In some embodiments, the systems and methods disclosed herein may be used to stored files of a distributed file system. As used herein, a file is a collection of data stored in one unit under a filename. Embodiments of a distributed file system suitable for accommodating embodiments of heterogeneous storage system disclosed herein are disclosed in U.S. patent application Ser. No. 10/007,003, titled, “Systems And Methods For Providing A Distributed File System Utilizing Metadata To Track Information About Data Stored Throughout The System,” filed Nov. 9, 2001 which claims priority to Application No. 60/309,803, entitled “Systems And Methods For Providing A Distributed File System Utilizing Metadata To Track Information About Data Stored Throughout The System,” filed Aug. 3, 2001, U.S. Pat. No. 7,156,524 entitled “Systems And Methods For Providing A Distributed File System Incorporating A Virtual Hot Spare,” filed Oct. 25, 2002, and U.S. patent application Ser. No. 10/714,326 entitled “Systems And Methods For Restriping Files In A Distributed File System,” filed Nov. 14, 2003, which claims priority to Application No. 60/426,464, entitled “Systems And Methods For Restriping Files In A Distributed File System,” filed Nov. 14, 2002, all of which are hereby incorporated herein by reference in their entirety.

### IV. Storing Data On Heterogeneous Storage Containers

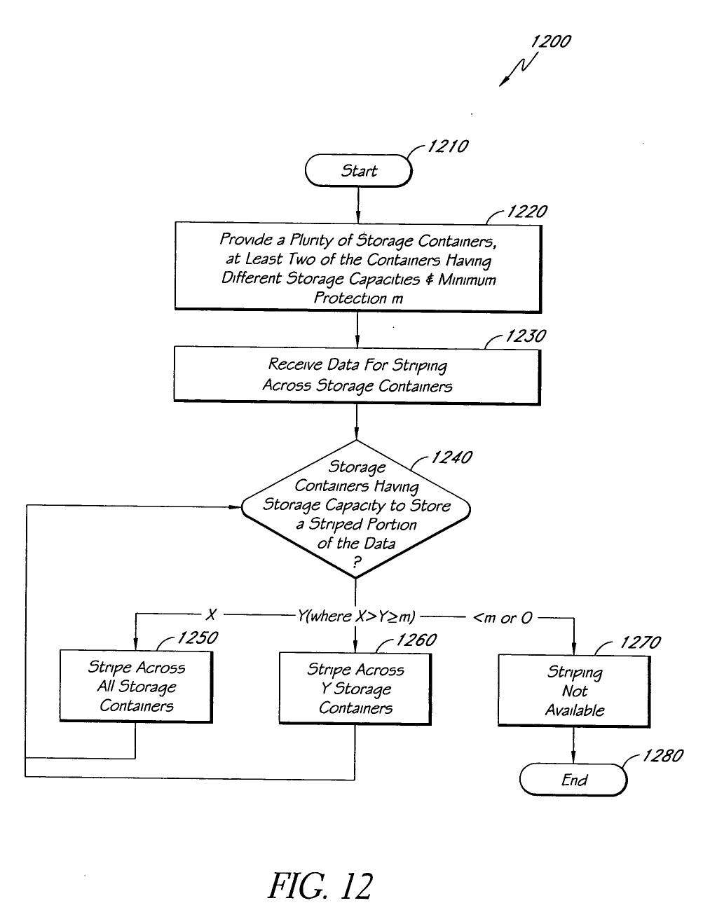

FIG. 12 illustrates a flowchart of one embodiment of storing data on heterogeneous storage containers 1200. Beginning at a start state 1210, the process 1200 provides two or more storage containers, wherein at least two of the storage containers have different storage capacities 1220 and a minimum protection scheme m for a set of data. Proceeding to the next state 1230, the process 1200 receives data for a file that is to be striped across the storage containers. Next, the process 1200 determines whether the storage containers have enough storage capacity to store a portion of the file on either all of the storage containers, a number less than all of the storage containers, but greater than or equal to m 1240. If the storage containers have enough storage capacity to store a portion of the file on all of the storage containers, the process 1200 stripes as much data as possible across all of the storage containers 1250 and returns to 1240. If the storage containers have enough storage capacity to store a portion of the file on a number less than all of the storage containers, but greater than or equal to m, the process 1200 stripes as much data as possible across the number of the storage containers 1260 and returns to 1240. If the storage containers do not have enough storage capacity to store a portion on the file across greater than or equal to m of the storage containers, then the process 1200 returns a message that striping is not available 1270 and proceeds to the end state 1280.

For example, if there are 4 containers, C₁, C₂, C₃, C₄, of size 3, 3, 4, and 6, the minimum amount of error correction is 1, and the file size is 12 blocks, the blocks will be stored as follows: the first nine blocks of the file and three parity blocks will be stored on containers C₁, C₂, C₃, C₄ at protection 3+1; the tenth block of the file and one parity block will be stored on containers C₃, C₄ at protection 1+1; and the eleventh and twelfth block will not be stored on the containers because while the remaining space can store the last two blocks, it cannot store the last two blocks with the minimum protection.

While FIG. 12 illustrates one embodiment of storing data on differently sized storage containers, it is recognized that a variety of embodiments may be used. For example, the process 1200 could store the data until all of the containers are full, but indicate which data has not been stored using the minimum protection scheme. Moreover, depending on the embodiment, certain of the blocks described in the figure above may be removed, others may be added, and the sequence may be altered.

### V. Storing Data Using Multiple Protection Schemes

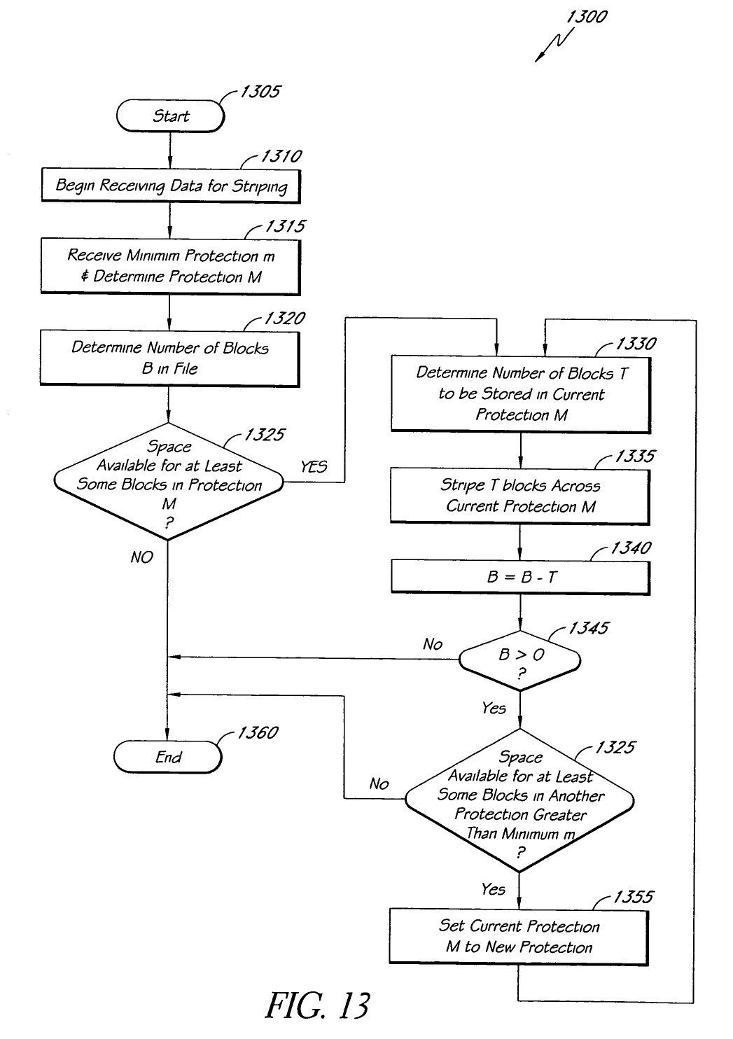

FIG. 13 illustrates a flowchart of one embodiment of storing data using multiple protection schemes 1300. Beginning at a start state 1305, the process 1300 proceeds to the next state and begins receiving a file or other data for striping 1310. Proceeding to the next state, the process 1300 receives a minimum protection m 1315 and determines the protection M using m and the total number of containers. The process then determines the number of blocks B in the file 1320 and determines whether there is space available for at least some of the blocks in current protection M 1325. If not, then the process 1300 proceeds to an end state 1360. If there is space available, then the process 1330 determines the number of blocks T to be stored in the current protection M 1330 and stripes T blocks across the containers using the current protection M 1335. The process 1300 then sets B=B−T and determines whether there are any remaining blocks (B>0). If not, then the process 1300 proceeds to an end state 1360. If there are remaining blocks, then the process 1300 determines whether there is space available for at least some of the remaining blocks at another protection scheme 1350 that is greater than the minimum protection m. If not, then the process 1300 proceeds to an end state 1360. If so, then the process 1300 sets the current protection M to the new protection scheme and proceeds to block 1330. The process 1300 then repeats until there are no more blocks in 1345 or there is not enough space available for another protection scheme 1350.

For example, if there are 4 containers, C₁, C₂, C₃, C₄, of size 3, 3, 4, and 6, the minimum amount of error correction is 1, and the file size is 12 blocks. In FIG. 13, m=1 and so M=3+1 with B=12. The process 1300 will determine that there is space available for at least some of the blocks B at 3+1 storage and will determine that it can store T=9 blocks under 3+1 protection. The process 1300 will store the blocks and recalculate B=12−9=3. Since 3>0, then the process 1300 will check to see if there is space available for the blocks B at another protection scheme, and since 1+1 is available, it will set M=1+1. Next, the process 1300 will determine that it can store T=1 block at M=1+1 protection and stripe the blocks using M=1+1 protection. The process 1300 will store the blocks and recalculate B=3−1=2. Since 2>0, then the process 1300 will check to see if there is space available for the blocks B at another protection scheme and since there is not, the process will proceed to the end state.

While FIG. 13 illustrates one embodiment of storing data on differently sized storage containers, it is recognized that a variety of embodiments may be used. For example, the process 1300 could determine the current protection scheme based received data. In addition, the process 1300 could wait until all of the blocks of the file have been received before proceeding with the striping or wait until only enough of the file is received so make a determination regarding the storage of the blocks in a first protection scheme. Furthermore, the process 1300 could return a message stating the number of blocks that have not been stored. Moreover, depending on the embodiment, certain of the blocks described in the figure above may be removed, others may be added, and the sequence may be altered.

### VI. Other Embodiments

While certain embodiments of the invention have been described, these embodiments have been presented by way of example only, and are not intended to limit the scope of the present invention. Accordingly, the breadth and scope of the present invention should be defined in accordance with the following claims and their equivalents.

Some of the figures and descriptions relate to an embodiment of the invention wherein the environment is that of a distributed system. The present invention is not limited by the type of environment in which the systems, methods, processes and data structures are used. The systems, methods, structures, and processes may be used in other environments, such as, for example, other distributed systems, the Internet, the World Wide Web, a private network for a hospital, a broadcast network for a government agency, an internal network of a corporate enterprise, an intranet, a local area network, a wide area network, a wired network, a wireless network, and so forth. It is also recognized that in other embodiments, the systems, methods, structures and processes may be implemented as a single module and/or implemented in conjunction with a variety of other modules and the like.

It is also recognized that the term “remote” may include data, objects, devices, components, and/or modules not stored locally, that is not accessible via the local bus or data stored locally and that is “virtually remote.” Thus, remote data may include a device which is physically stored in the same room and connected to the user's device via a network. In other situations, a remote device may also be located in a separate geographic area, such as, for example, in a different location, country, and so forth.

The above-mentioned alternatives are examples of other embodiments, and they do not limit the scope of the invention. It is recognized that a variety of data structures with various fields and data sets may be used. In addition, other embodiments of the flow charts may be used.

What is claimed is:

1. A storage system comprising:
a plurality of n storage containers, x₁, x₂, to xₙ, configured to store logical data and data protection data, wherein:
n is greater than 1;
the size of x₁≦the size of x₂≦ . . . the size of xₙ₋₁≦the size of xₙ and the size of x₁<the size of xₙ;
the plurality of n storage containers utilize more than ((n−m)*size of x₁) for storing logical data, where m is the number of failed storage containers the system can handle; and
the logical data and data protection data may include striped data and mirrored data.

2. The storage system of claim 1, wherein the plurality of n storage containers store at least one non-mirrored stripe of data.

3. The storage system of claim 1, wherein the storage container is node of a distributed system.

4. The storage system of claim 1, wherein the storage container is a locally accessed disk drive.

5. The storage system of claim 1, wherein the storage container includes at least one of a drive, a node, a disk, a cluster, an object, a drive partition, a virtual volume, a volume, and a drive slice.

6. The storage system of claim 1, wherein the storage containers are configured to be dynamically configured.

7. The storage system of claim 1, wherein the storage containers include a plurality of data protection schemes on the same containers.

8. A storage system comprising:
a plurality of n storage containers, x₁, x₂, to xₙ, configured to store logical data and data protection data, wherein:
n is greater than 1;
the size of x₁≦the size of x₂≦ . . . the size of xₙ₋₁≦the size of xₙ and the size of x₁<the size of xₙ;
the plurality of n storage containers utilize more than ((n−m)*size of x₁) for storing logical data, where m is the number of failed storage containers the system can handle; and
the storage containers are locally accessed disk drives.

9. The storage system of claim 8, wherein the logical data and data protection data may include striped data and mirrored data.

10. The storage system of claim 8, wherein the plurality of n storage containers store at least one non-mirrored stripe of data.

11. The storage system of claim 8, wherein the storage containers are configured to be dynamically configured.

12. The storage system of claim 8, wherein the storage containers include a plurality of data protection schemes on the same containers.

13. A storage system comprising:
a plurality of n storage containers, x₁, x₂, to xₙ, configured to store logical data and data protection data, wherein:
n is greater than 1;
the size of x₁≦the size of x₂≦ . . . the size of xₙ₋₁≦the size of xₙ and the size of x₁<the size of xₙ;
the plurality of n storage containers utilize more than (n*size of x₁) for storing physical data; and
the logical data and data protection data may include striped data and mirrored data.

14. The storage system of claim 13, wherein the plurality of n storage containers store at least one non-mirrored stripe of data.

15. The storage system of claim 13, wherein the storage container is node of a distributed system.

16. The storage system of claim 13, wherein the storage container is a locally accessed disk drive.

17. The storage system of claim 13, wherein the storage container includes at least one of a drive, a node, a disk, a cluster, an object, a drive partition, a virtual volume, a volume, and a drive slice.

18. The storage system of claim 13, wherein the storage containers are configured to be dynamically configured.

19. The storage system of claim 13, wherein the storage containers include a plurality of data protection schemes on the same containers.

20. A method of storing data on heterogeneous storage containers, the method comprising:
receiving a total number of storage containers;
receiving a minimum number of protection blocks;
determining a first protection scheme;
storing a first plurality of stripes of data across all of the storage containers at the first protection until the smallest container of all of the storage containers is full;
determining a second protection scheme; and
storing a second plurality of stripes of data across the non-full storage containers at the second protection until the smallest container of the non-full storage containers is full.

21. The method of claim 20 further comprising
determining a third protection scheme; and
storing a third plurality of stripes of data across the non-full storage containers at the second protection until the smallest container of the non-full storage containers is full.
